(19) United States
(12) Patent Application Publication
(10) Pub. No.: US 2024/0309753 A1
(43) Pub. Date: Sep. 19, 2024

(54) MEASUREMENT TOOL INSTALLATION APPARATUS AND METHOD

(71) Applicant: REFLEX INSTRUMENTS ASIA PACIFIC PTY LTD, Balcatta, Western Australia (AU)

(72) Inventors: John Carl Jackson, Balcatta (AU); Lachlan Kennelly, Balcatta (AU); Lee Webb, Balcatta (AU); Roland Greenwood, Balcatta (AU)

(21) Appl. No.: 18/681,234

(22) PCT Filed: Aug. 3, 2022
(86) PCT No.: PCT/IB2022/057179

§ 371 Date: Feb. 5, 2024

(30) Foreign Application Priority Data
Aug. 3, 2021 (AU) 2021902388

(51) Int. Cl. E21B 47/08; E21B 19/084; E21B 23/14

(52) U.S. Cl. CPC E21B 47/08; E21B 19/084; E21B 23/14

(57) ABSTRACT

An installation apparatus for a measurement tool in an underground mine with overhead drill holes, the installation apparatus comprising: a support that can be removably secured to the ceiling, wall and/or ground of the mine, and an installation conduit that can be removably coupled to the support and aligned with the drill hole to deploy a survey and/or geophysical tool into the open drill hole.

### FIELD OF INVENTION

The present disclosure relates to an apparatus and/or method for surveying holes in underground mines or similar.

### BACKGROUND

In underground mines, overhead drill holes in the roof of the mine require surveying. Traditionally, that requires the use of an elevated platform (for example a scissor lift) preferably with a basket or similar apparatus to lift a person(s) to the entry point of the hole or as is known in the industry the “collar” of the hole.

This workflow process presents numerous health and safety concerns. To reduce risk while a survey log is taken, then the workflow process usually requires one person to operate the elevated platform with at least two people on the platform or in the basket to position and operate a survey tool to ensure an accurate survey of the hole is carried out with another person on the ground operating the lift or is there for health and safety reasons. In more complicated underground mine sites, more than 3 people may be required.

It should be noted that underground mines, although not too dissimilar from above ground mines, have a different set of problems which are not encountered in above ground mines. These include for example operating within a confined physical space, ensuring adequate ventilation of air, structural integrity of the mine space is maintained, manoeuvrability, poor visibility with limited peripheral vision, trip hazards, obstructing objects etc. However, the economic drivers of the mine to mill communition process including optimisation of on-site mine workflows, minimization of environmental impacts and increasing health and safety factors equally apply to an underground mine.

### SUMMARY OF INVENTION

It is an object of the present invention to provide a method and/or apparatus for surveying holes in underground mines or similar.

In the specification, reference to top end, bottom end and upright position can be relative to when the installer has been installed and is in use. When the installer is not in use and/or is disassembled (e.g., it might be placed horizontally on the ground), these terms can still be used even if the installer is not upright and/or the ends are not at the top and the bottom.

The problems and drivers present in underground mine surveying contribute towards mine sites looking at ways to improve efficiencies in these areas while simultaneously improving health and safety for its employees.

In one aspect the present invention may be said to comprise an installation apparatus for a measurement tool in an underground mine with overhead drill holes, the installation apparatus comprising: a support that can be removably secured to the ceiling, wall and/or ground of the mine, and an installation conduit that can be removably coupled to the support and aligned with the drill hole to deploy a survey and/or geophysical tool into the open drill hole.

Optionally the installation apparatus further comprises: a measurement tool support to support the measurement tool and/or peripheral components before and/or after deployment.

Optionally the drill hole is: up to or about 50 m in length, or up to or about 40 m, or up to or about 30 m in length and/or at least about 50 mm or up to or about 25 cm in diameter. Optionally the measurement tool support comprises a base and/or connector to support the tool.

Optionally the conduit comprises a viewing and/or communication region to assess the measurement tool.

Optionally the support and/or conduit are extendible and/or collapsible in the longitudinal direction, preferably telescopically.

Optionally the support is a pole.

### Optionally the Pole is:

a single pole, or
a pole with plural sections, optionally with a gap.

Optionally the pole has retainers at one or both ends for securing the support to the ceiling, ground and/or wall, wherein optionally the retainers are feet.

Optionally the measurement tool is one or more of
survey tool, such as a gyro
geological data collecting tool to collect geophysical, petrophysical, mineralogical, compositional data and/or hole geometry data.

In another aspect the present invention may be said to comprise a method of installing a measurement tool in an underground mine with overhead drill holes into a formation comprising, in any order: installing a support between the ground, ceiling and/or wall of a mine, attaching an installation conduit to the support, aligning the support and/or conduit with an overhead drill hole, feeding a measurement tool in the conduit to deploy the tool in the drill hole.

Optionally the method further comprises determining if the measurement tool is approaching the overhead drill hole and/or is correctly placed.

Optionally the method further comprises retaining the measurement tool and/or peripheral components in a tool support.

In another aspect the present invention may be said to comprise a system to survey overhead drill holes in a mine comprising:
a cable reel with cable,
an installation apparatus according to any one of claims 1 to 8, and a measurement tool attached to the cable.

In another aspect the present invention may be said to comprises a method of taking measurements in an underground mine with overhead drill holes comprising using an installation apparatus according to one of the paragraphs above and/or described herein.

In one aspect the present invention may be said to comprise an installation apparatus for a measurement tool in an underground mine with overhead drill holes, the installation apparatus comprising: a support that can be removably secured to the ceiling, wall and/or ground of the mine, and an installation conduit that can be removably coupled to the support and aligned with the drill hole to deploy a survey and/or geophysical tool into the open drill hole.

Optionally the installation apparatus further comprises: a measurement tool support to support the measurement tool and/or peripheral components before and/or after deployment.

### Optionally the Drill Hole is:

up to or about 50 m in length, or up to or about 40 m, or up to or about 30 m in length and/or
at least about 50 mm or up to or about 25 cm in diameter.

Optionally the measurement tool support comprises a base and/or connector to support the tool.

Optionally the conduit comprises a viewing and/or communication region to assess the measurement tool.

Optionally the support and/or conduit are extendible and/or collapsible in the longitudinal direction, preferably telescopically.

Optionally the support is a pole.

### Optionally the Pole is:

a single pole, or
a pole with plural sections, optionally with a gap.

Optionally the pole has retainers at one or both ends for securing the support to the ceiling, ground and/or wall, wherein optionally the retainers are feet.

### Optionally the Measurement Tool is One or More of

survey tool, such as a gyro
geological data collecting tool to collect geophysical, petrophysical, mineralogical, compositional data and/or hole geometry data.

In another aspect the present invention may be said to comprise a method of installing a measurement tool in an underground mine with overhead drill holes into a formation comprising, in any order:
installing a support between the ground, ceiling and/or wall of a mine,
attaching an installation conduit to the support,
aligning the support and/or conduit with an overhead drill hole, feeding a measurement tool in the conduit to deploy the tool in the drill hole.

Optionally the method further comprises determining if the measurement tool is approaching the overhead drill hole and/or is correctly placed.

Optionally the method further comprises retaining the measurement tool and/or peripheral components in a tool support.

In another aspect the present invention may be said to comprise a system to survey overhead drill holes in a mine comprising:
a cable reel with cable, an installation apparatus according to any one of claims 1 to 8, and a measurement tool attached to the cable.

Optionally the rodder reel comprises a base that supports a cable reel, at least one wheel and a handle for manoeuvring the rodder reel.

Optionally the cable reel supported on a gantry that extends from the base.

Optionally the wheel is supported on a transport frame that is coupled to the base via a gantry or directly.

Optionally the handle is attached to the transport frame.

Optionally the wheel is attached to the transport frame.

Optionally the system further comprises a gantry attached to the base for supporting an encoder.

In another aspect the present invention may be said to comprise a rodder reel for use in surveying comprising: rodder reel frame with a base, a cable reel the rodder reel frame, at least one wheel and a handle for manoeuvring the rodder reel.

Optionally the rodder reel further comprises a gantry extending from the base wherein the is cable reel supported on a gantry that extends from the base.

Optionally the rodder reel further comprises a transport frame coupled to the base via the gantry or directly, wherein the wheel is supported on a transport frame.

Optionally the handle is attached to the transport frame.

Optionally the rodder reel further comprises a gantry attached to the base for supporting an encoder.

Optionally the rodder reel frame also comprises cable reel support and a transportation support.

Optionally the rodder reel frame is a single piece.

Optionally rodder reel further comprises a handle, and the wheel and the handle are on opposite sides of the rodder reel frame.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The term “comprising” as used in this specification means “consisting at least in part of”. Related terms such as “comprise” and “comprised” are to be interpreted in the same manner.

This invention may also be said broadly to consist in the parts, elements and features referred to or indicated in the specification of the application, individually or collectively, and any or all combinations of any two or more of said parts, elements or features, and where specific integers are mentioned herein which have known equivalents in the art to which this invention relates, such known equivalents are deemed to be incorporated herein as if individually set forth.

### BRIEF DESCRIPTION OF DRAWINGS

The embodiments described above by way of example only, and should not be considered limiting. Some variations are as follows.

Embodiments will now be described with reference to the following drawings, of which:

FIG. 1 shows an installer in use to install a measurement tool in an overhead drill hole in a mine.

FIG. 2 shows the installer in more detail.

FIG. 2A shows a foot plate of a support pole and a clamp.

FIG. 3 shows a support pole attachment for the installer.

FIGS. 4A, 4B show a measure tool support for a measurement tool.

FIG. 4C shows an alternative measurement tool support for a measurement tool.

FIG. 4D shows a connector in detail.

FIG. 4E shows a further alternative measurement tool support for a measurement tool.

FIG. 4F shows a connector in detail.

FIG. 5 shows a rodder reel.

FIGS. 6 to 8B show an alternative embodiment of a rodder reel.

FIG. 9A, 9B shows a rodder reel with two variations of supporting members in place with example equipment in place.

FIG. 10 shows another alternative embodiment of a rodder reel.

### DETAIL DESCRIPTION

### 1. Overview

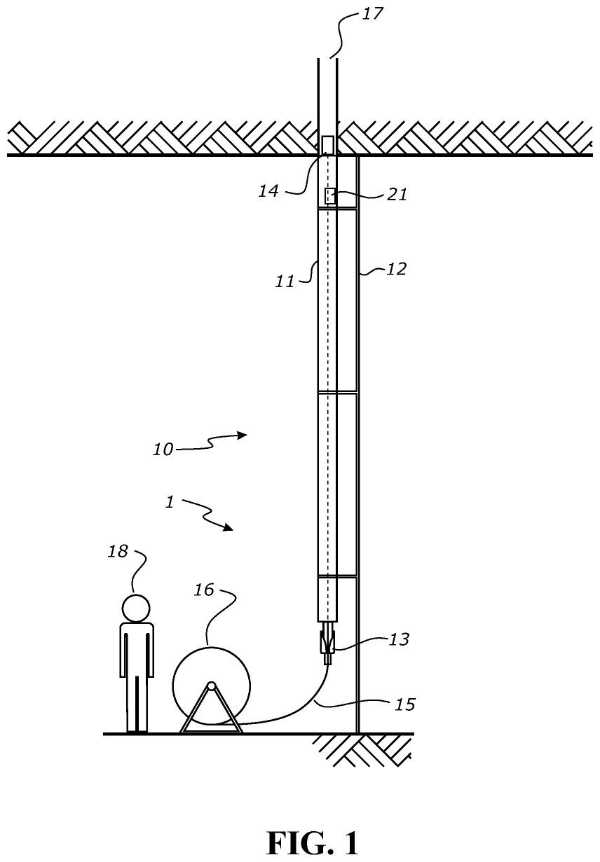

Referring to FIG. 1, an installation assembly (system) 1 is shown. It comprises a rodder reel 16 with cable 15 that is coupled to a measurement tool 14; and installer 10. The arrangement enables surveying of drill holes 17 in a manner that will be described further below.

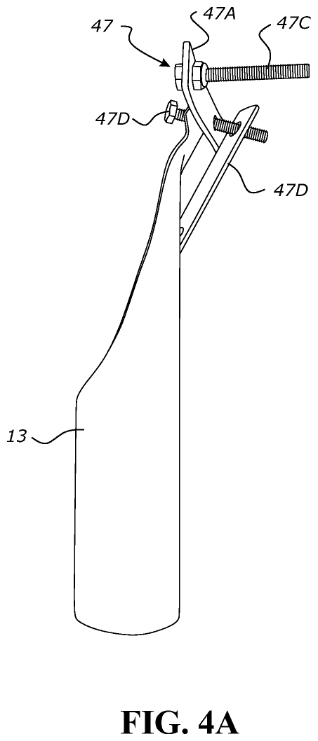

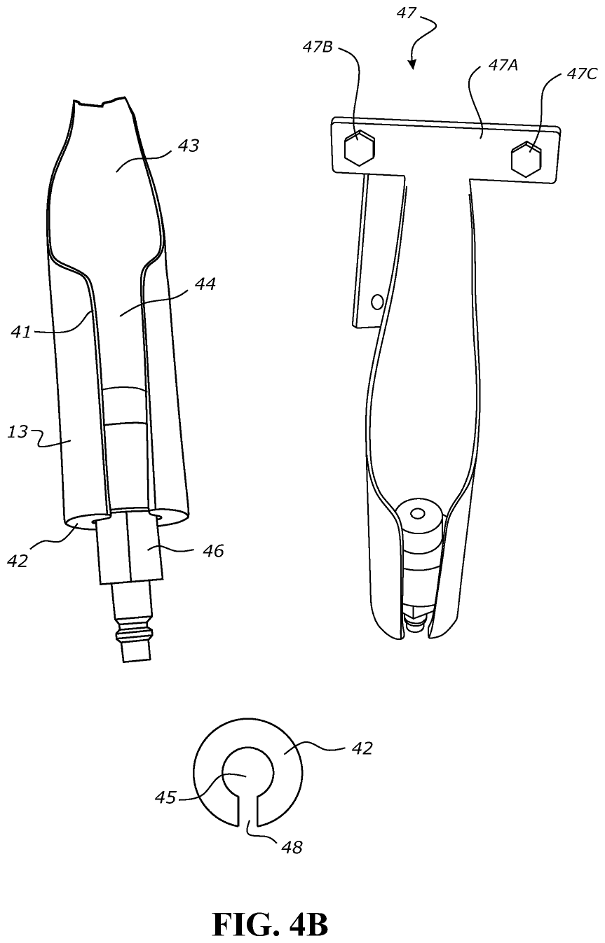

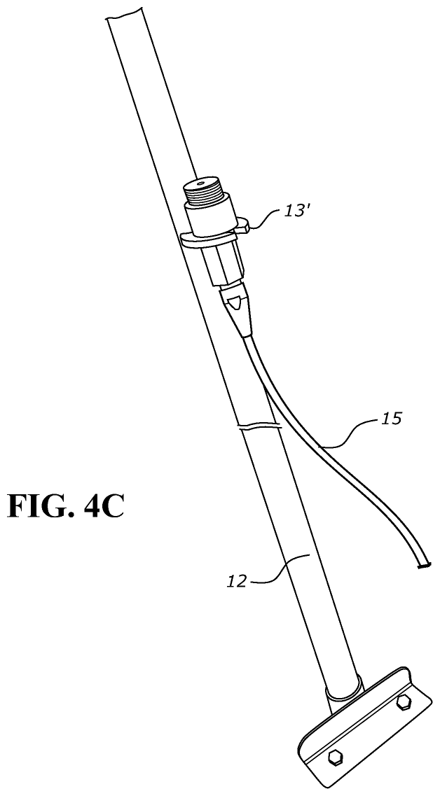

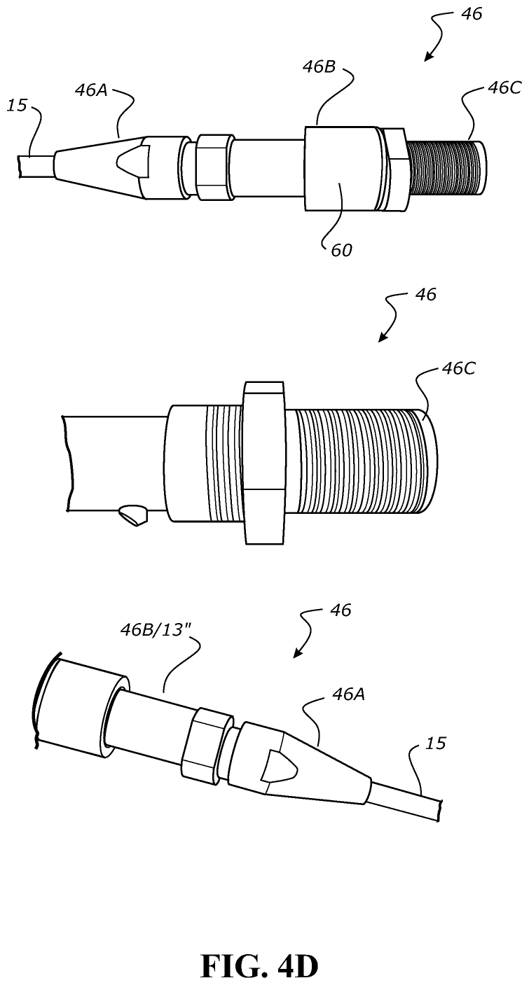

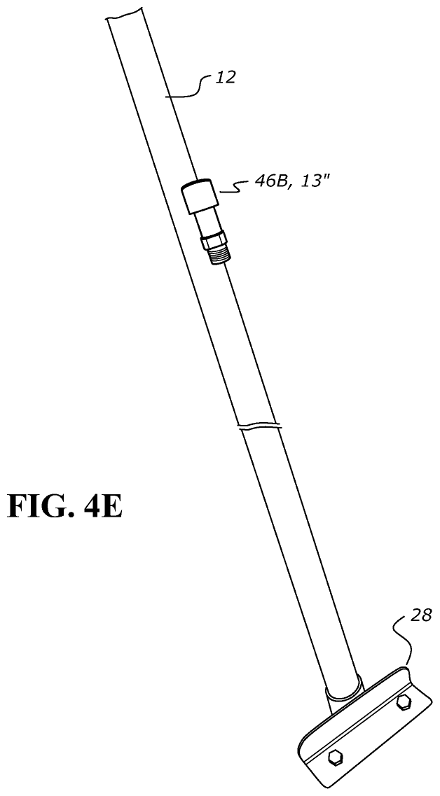

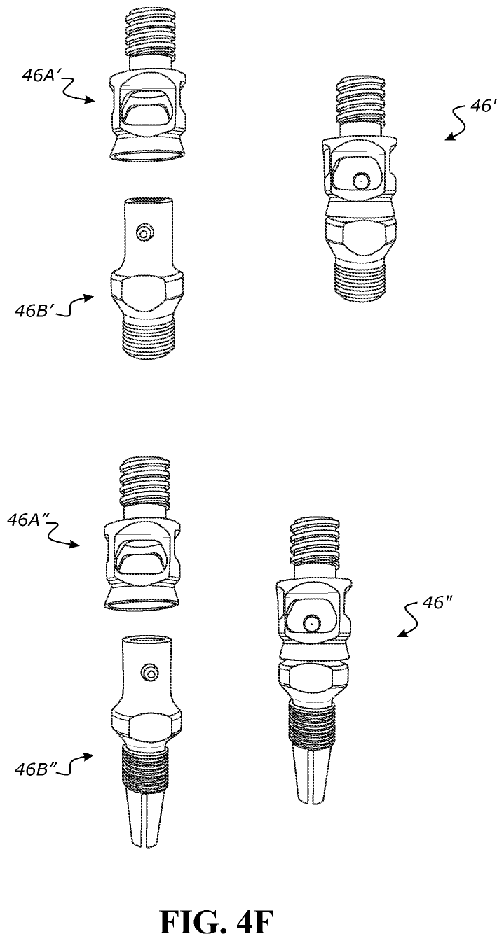

The installer 10 comprises an installation conduit 11 which has a diameter that allows for a measurement tool 14 to pass through. The installer also has a support pole 12 which is permanently or removably coupled to the installation conduit 11, to support and manoeuvre the installation conduit. A measurement tool support (such as a holder/retainer, clip, hook or the like) 13 (see FIGS. 4A, 4B) is provided, attached to the support pole 12 and/or the conduit 11. The installer 10 may comprise the various components as a permanently integrated arrangement or as individual components, in e.g., a kit of parts, that comes ready assembled and/or are assembled on site as required.

In use, a measurement tool 14 is placed in, on, is attached to, held by and/or is otherwise supported by the support 13 and is connected to the cable 15 on the rodder reel 16. In some embodiments, the cable can provide power, control and/or data communication. Using the support pole 12, the installer 10 is manoeuvred so that a top opening of the installation conduit 11 is aligned with and/or inserted at least partially into an overhead/above head drill hole 17 in the roof of a mine. The pole 12 can be used to support (position, hold upright and/or secure) the installer conduit 11 in position. Once the user has set the tool up for measuring, a user 18 can then feed the cable 15 from the reel 16 and push the measurement tool 14 from the support up through the installation conduit 11 and into the drill hole 17 (as shown in FIG. 1), where measurement can take place. A viewing and/or communications region 21 can assist with: visual and communications based assessment of the tool position, control communications (including tool initialisation) with the tool, and/or data communication with the tool. The region can be located at any suitable place along the conduit to allow viewing and communications. Once measurement is complete and communicated to a monitoring device, e.g. a tablet, smartphone, computer or other device that can record data from and/or control the tool, the reverse can happen, wherein the measurement tool 14 can be lowered down from the drill hole 17, while carrying out measurement on the out run and guided down through the installation conduit 11 back to the tool support 13, after which the installer 10 can then be removed, collapsed (e.g. if telescopic) and/or disassembled (in whole or in part) and/or moved to the next drill hole for inspection. In the alternative, the recordings of the measurement (data) are stored in the memory on board the tool itself such that the information is downloaded after being lowered back down hole or at any other suitable time. Alternatively, the data can be downloaded via the cable. The cable can also provide power to the tool.

As a non-limiting example the drill holes could be development holes and/or production holes.

Typically, drill holes will be up to or about 50 m, or up to or about 45 m, or up to or about 40 m, or up to or about 35 m, or up to or about 30 m, or up to or about 25 m, or up to or about 20 m in length, with the use of a non-crawler measurement tool. Although the present invention can work for any length drill hole and with crawler measurement tools. The drill holes are at least about 50 mm or up to about 25 cm in diameter.

### 2. Exemplary Embodiment—Installer Apparatus

One example of the installer 10 will now be described. The installer is used to install a measurement tool 14 that is connected to a cable 15 that is fed from a rodder reel 16. The measurement tool 14, cable 15 and rodder reel 16 do not form part of the installer per se, but can be considered part of an overall system that incorporates the installer.

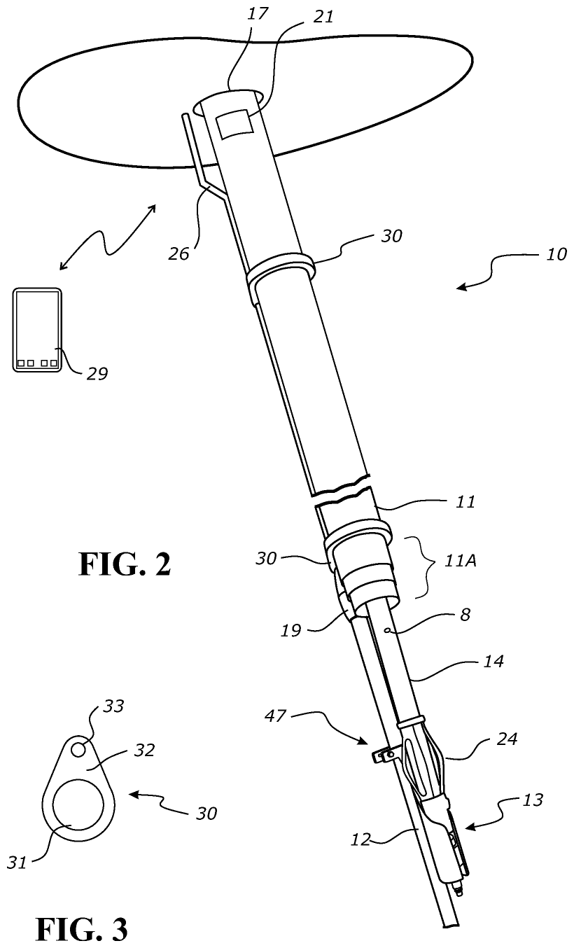

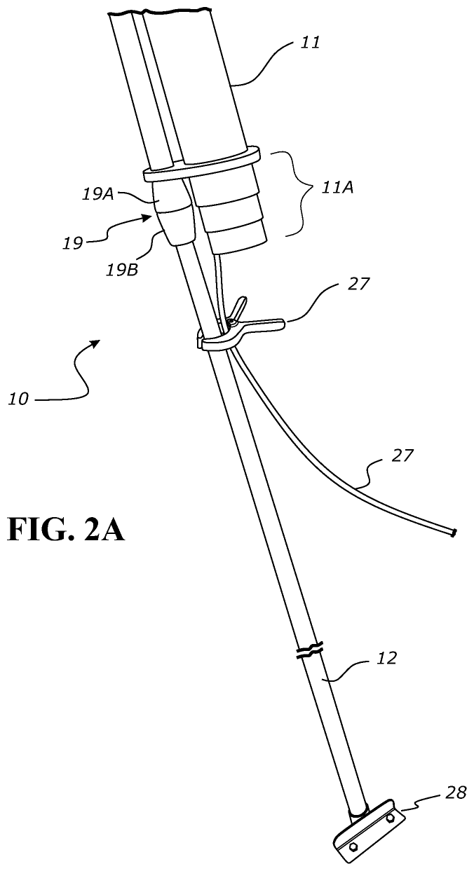

Referring to FIGS. 1 and 2, the installation conduit 11 comprises a plastic (e.g. PVC), metal or other conduit constructed of suitable material. It is preferable that the material from which the conduit is made is as lightweight as possible yet rigid enough to at least partially support its own weight. The length of the installation conduit is configured suitable for the height of the mine it is being used in. Possibly, the length of the installation conduit is configurable, e.g. through telescoping parts-such as shown in FIG. 2A. Part or all of the installation conduit could be telescoping. e.g. the top and/or bottom parts of the installation conduit could be telescoping through e.g. nested tubes. As an example, the bottom portion 11A of the conduit is shown telescoping in FIG. 2, with nestable sections that slide in and out of each other.

The conduit 11 has a viewing and/or communications region 21, such as a window, opening or the like at a suitable known position so that once the conduit 11 is arranged in place with the drill hole 17, a user can assess (e.g. view) the position of the measurement tool 14 as it approaches a collar (opening) of the drill hole and/or reaches a known position relative to the collar. The region 21 can be at any suitable location. This can assist with tool installation and/or tool communication.

For example, the tool 14 can be provided with an indicator (e.g. light 8) that can be viewed through the viewing/communications region. The indicator can be fixed to the tool at a known position, such that as the light reaches the viewing/communication region 21, the user can determine the position of the tool relative to the conduit and/or drill hole. During installation, the user plays out the cable (with tool attached) from the rodder reel, and feeds the cable and tool into the conduit and up towards the drill hole collar. As the light reaches the viewing region the user can prepare for positioning and operation of the tool (to be described more later).

Alternatively or additionally the viewing and/or communications region 21 (or other part of the conduit) can allow for transmission of electromagnetic (e.g. radio and/or light) signals so the region 21 can also facilitate wireless communications with and/or detection of the measuring tool 14 via suitable sensors and/or transceivers (e.g. through BlueTooth or other wireless transmission protocol). This additionally or alternatively allows the user to determine when the tool 14 has reached the collar and/or a known position relative to the collar and/or has been inserted into the collar. Also, for example, the region 21 can be used to communicate with the tool 14 from a monitoring device 29 to control and/or record data from the device (to be described in more detail later)

As shown in FIG. 2A cable retainer 27, such as a clamp, can be provided to the pole 12, conduit 11 and/or other part of the installer 10. This allows for securing of the cable in a taught manner to mitigate wobble of the: a) cable in the conduit and b) the tool 14 when the tool is installed and/or while carrying out measurement of the drill hole

The conduit 11 has support pole attachments 30—see FIG. 3. In this embodiment, the support pole attachments take the form of annular collars 30 with a central aperture 31. The annular collars are positioned around the outer surface of the installation conduit 11, and are spaced apart at suitable intervals along the length of the conduit 11. The attachments 30 can be adhered, friction fit, mechanically fixed (e.g. screws or the like) or otherwise attached to the conduit. Each annular collar 30 has a coupling 32 for a support pole, in this case in the form of a lug 32 extending from the annular collar 30 with an aperture 33 having a diameter commensurate with the diameter of the support pole 12.

The installer support pole 12 is constructed of a metal and/or other material that can support its own weight and also provide support and rigidity to the installation conduit 11. For example, the support pole 12 can be collapsible (e.g. telescopic and/or can be disassembled), lightweight and strong and preferably constructed of materials stiffer than the conduit so it can be the main stabiliser for the installer 10. The support pole 12 is preferably longer than the conduit 11, although this is not essential. The length of the pole is configured suitable for the height of the mine it is being used in and/or the transportation vehicle. Possibly, the length of the pole is configurable, e.g., through telescoping parts and/or parts that can disassemble. The support pole might be telescopic so the length is configurable and allows for ease of transport.

The support pole 12 can pass through the apertures 33 of each attachment collar 30 to attach to the installation conduit 11. The support pole 12 can be removably coupled, or permanently coupled to the installation conduit 11. In the present embodiment, the support pole 12 is removably coupled by way of passing the support pole through the apertures 33 of the attachments 30. There may be somewhat of a friction fit, to provide at least some friction and to prevent free sliding of the conduit 11 relative to the pole 12 through the attachment apertures 33, but also alternatively there may not be any friction fit, and the apertures 33 are large enough to allow the free sliding of the pole 12 within the apertures 33. It will be appreciated that other arrangements of a support pole attachment could be envisaged and this is just one example.

In either case, to prevent the installation conduit 11 sliding down relative to the support pole when the installer is installed in an upright position, a positioning adjuster 19 is attached to the support pole and/or installation conduit. The positioning adjuster 19 can be moved up and down the support pole 12 and releasably locked to position the conduit 11 longitudinally relative to the support pole 12. The positioning adjuster 19 comprises a locking nut 19A and/or 19B, that is slidable up and down the pole 12 and which can frictionally (or otherwise) lock and unlock to and/or from the support pole 12. The positioning adjuster 19 also has a collar abutment. When the locking nut is locked to the support pole 12, a collar 30 and/or bottom end of the installation conduit 11 will rest under gravity on the collar abutment to prevent the installation conduit 11 sliding further down the support pole 12. When the locking nut is un-done, the locking nut can slide down the pole 12 which also allows for the conduit 11 to slide relative to the pole. This enables the conduit 11 to be positioned along the pole 12 at a certain height when installed in the upright position and also allows the conduit 11 to freely slide travel up and down the pole 12 when and/or as required. The locking nut in this embodiment only prevents sliding of the conduit downwards relative to the support pole 12, but in other embodiments, the locking arrangement could prevent sliding upwards of the conduit 11 also.

It will be appreciated that other arrangements of a positioning adjuster could be envisaged and this is just one example.

The support pole 12 has a stabiliser to secure the support pole (and therefore the conduit 11) to a suitable fixed surface, such as a ceiling, floor and/or wall of the mine. For example, in this embodiment, the stabiliser assists with locating the conduit 11 close to the collar and at an opposite end that engages the ground to lock the conduit into place. As such, the stabiliser comprises:
At the top end of the support pole 12, forked prongs 26 (or alternatively a plate, e.g. similar to the foot plate 28) for positioning/supporting the installation conduit relative to the mine ceiling/drill hole. The prongs 26 can be placed close to the collar of the hole to enable a force to be applied in an upward direction that is spread about the hole rather than concentrated in one place where the formation may, for example, be crumbly or the like.
At the bottom end of the support pole 12, a retainer 28 (such as a foot (e.g. claw or similar that is provided to a foot plate)) that is extendable to engage the floor of the mine and lodge the pole 12 in place through force between the ceiling via the prongs and floor. FIG. 2A shows an example of the foot plate on the support pole 12, where the foot plate on the underside can be provided with prongs or other projections to engage with the ground and to hold the support pole in place. The plate can then readily be prised up from the ground and as it is provided on a tubular portion, can readily move up along the support pole to enable a user to then readily move the installer to another position.

The retainer and forked prongs can be termed couplings.

The measurement tool support 13 is shown in more detail in FIGS. 2, 4A, 4B, and in this example (without limitation) takes the form of a holder (it could alternatively be another support, such as, without limitation, a clip, hook, or the like). The holder can take any suitable form where there is a support portion for the measurement tool 14 (and/or peripheral components like cable 15, connectors and the like) and an attachment portion to attach the holder to the installer 10, e.g., the support and/or conduit. In this embodiment, the holder 13 takes the form of a partially cylindrical body/wall 41, with a support base 42 (see insert). The partial cylindrical body 41 has a large lateral opening 43 towards the top end and does not fully close circumferentially at the lower portion to provide a narrow longitudinal opening 44 along the length of the holder 13. This allows for insertion of a measurement tool 14 which is coupled to a cable 15. The measurement tool 14 can be passed laterally through the large opening 43, while a connected cable 15 can slide laterally through the longitudinal opening 44. Likewise, the support base 42 has an aperture 45 and also a radial opening (slot) 48 (which lines up with the narrow opening 44) to allow for a connector 46 of the measurement tool and/or a cable to pass through. The measurement tool 14 once inserted into the holder can be positioned so that a larger diameter portion of the measurement tool sits on the support base 42, while a smaller diameter portion and/or the cable and/or connector protrude through the base aperture 45.

Preferably the holder 13 is removeable. The holder has an attachment portion 47, in the form of a clamp comprising a lateral support 47A at the top of the holder with two closure mechanisms, such as bolts 47B, 47C, and a removable plate 47D. The lateral support 47A and plate 47D can be positioned either side of the support pole 12, and then the bolts 47B, 47C tightened to clamp the holder 13 to the support pole 12. Preferably, the holder 13 is positioned at a suitable length below a bottom opening of the installation conduit 11.

An alternative measurement tool support 13′ is shown in FIG. 4C. This comprises an annular ring with an opening that supports a portion of the connector 46. This could be the support base 42 of the previous embodiment, for example. The wide portion of the connector rests on the annular ring. The connector 46 and cable 15 can locate on the annular ring 13′ and a tool 14 can connect as per previously described.

The connector 46 is shown in more detail in FIG. 4D. The connector 46 has a quick release mechanism and generally comprises three parts, that together connect the cable and measurement tool together. The first part is a cable connector 46A, and at one end has a threaded or bayonet fitting (hidden inside the middle part) to connect to a second middle part 46B. A cable 15 is provided to the other end of the cable connector 46A. The connector has a third part (tool connector) 46C, with a thread provided to couple to the measurement tool 14. The middle part 46B couples the first 46A and third 46C parts together with a quick release mechanism 60. This connector 46 being a quick release is easily detachable to enable the reel 16 containing the cable 15 to be moved away while the measurement tool 14 is retained within the conduit 11 and/or the base of the measurement tool is resting on the support base 42 while the body of the measurement tool is retained within the conduit.

In a yet further alternative embodiment, the tool support 13″ could be the middle section 46B of the connector-see FIG. 4D. It can be permanently or detachably coupled to the support pole 12. The cable 15 can be attached to the middle section 46B via the first cable connector 46A, and the tool 14 can be attached to the third section/tool connector 46C, which itself is coupled to the middle section 46B.

In yet a further alternative embodiments, two connector options 46′ and 46″ could be as shown in FIG. 4F. Each is a two part version instead of three as shown in FIG. 4D. Similar to the embodiment shown in FIG. 4D, the connector still has a quick release mechanism to connect the cable and measurement tool together. The first part 46B′, 46B″ has two ends, where a first end connects the cable and the second end has the quick release mechanism to engage with the second part 46A′, 46A″ of the connector, wherein the second part further connects to the measurement tool.

The installer may comprise the various components (installation conduit, support rod, holder and any other suitable parts) as a permanently integrated arrangement or as individual components, in e.g., a kit of parts, that come ready assembled and/or are assembled on site as required.

The measurement tool 14, cable 15 and rodder reel 16 will now be described in the context of the installer 10. The measurement tool, cable and rodder do not form part of the installer per se, but can be considered part of an overall system that incorporates the installer.

The measurement tool 10 could be any one or more of any suitable device used for interrogating the drill hole to collect data. Nonlimiting examples are
survey tool, such as a gyro, preferably a continuously measuring gyro.,
geological data collecting tool to collect geophysical, petrophysical, mineralogical, compositional data and/or hole geometry data.

The data includes but is not limited to any one or a combination of any two or more of the following:
Gamma radiation emitted by material in the hole
Density of material in the hole
Reflectivity of electromagnetic radiation
Reflectivity of acoustic or ultrasonic waves
Magnetic susceptibility of material in the hole
Electrical resistivity/conductivity/impedance of material in the hole
Magnetic vector field
Hole dip
Hole temperature
Sonic velocity
Contact hardness
Hole azimuth
Hole diameter
Hole profile
Hole volume
Water level and/or moisture content of hole

Suitable tools to collect such geological data include calliper, magnetic susceptibility, gamma, conductivity including focused conductivity, and the like.

A centraliser(s) 24 may in some instances be provided on the measurement tool 14 that is commensurate with the size of the drill hole 17 to allow location (e.g., centring) of the measurement tool 14 in the drill hole. The centraliser need not necessarily centre the tool in the drill hole as in some instances it might be desirable to have an eccentric offset of the tool inside the drill hole. Regardless, the centraliser assists with positioning the tool inside the drill hole, and in some embodiments a set of centralisers is used with a first centraliser provided to the bottom of the tool and a second centralizer to the top of the tool.

Optionally, a detector, in the form of e.g. a sensor and/or transceiver can be provided at the top end of the conduit to communicate with the tool 14 to indicate the tool is in position at or relative to the collar of the drill hole. Once positioning is confirmed, then the detector communicates to a receiver (e.g. at the bottom end of the conduit or separate to the conduit 11) to indicate the tool 14 is in position. The communication can utilise the viewing and/or communications region 21 of the conduit. The ability to be able to detect and/or communicate at this point, enables an accurate and repeatable determination of the position of the tool 14 by the user to identify that the tool is at the correct position without having to visually identify the same. That said, visual detection can be used instead or in addition to a detector, e.g. through a light.

The cable can carry power to the measurement tool, assisting with communications and substantially reducing the weight and length of the measurement tool. This can enable the transfer of the measurement data to the user in real time instead of requiring a download of the recorded memory onboard the measurement tool.

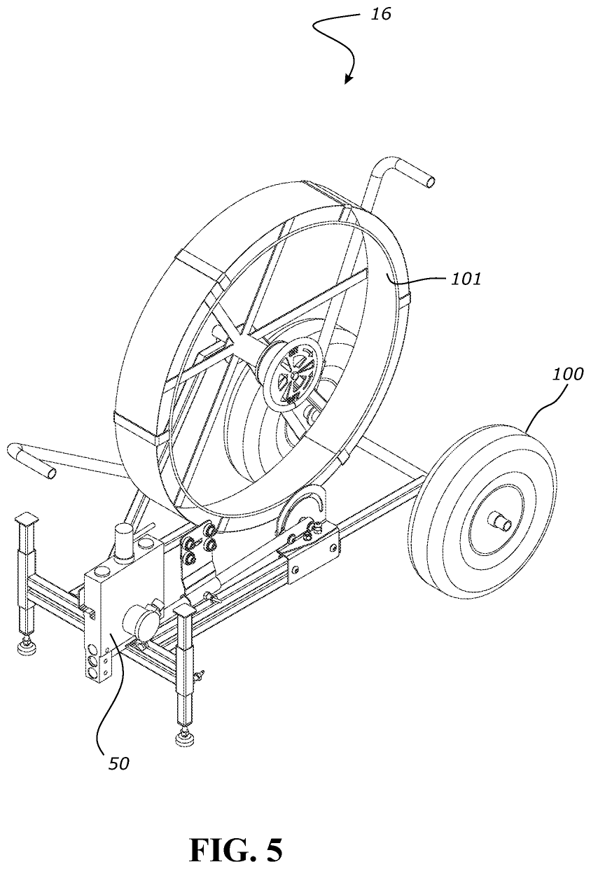

Referring to FIG. 5, the rodder reel 16 holds and feeds the cable that attaches to the measurement tool. The reel can be provided with a depthing encoder 50—this is a tool that measures the amount of cable played out by the reel so that the length of the drill hole and/or cable deployed can be determined. The reel can have a gearing and/or ratchet mechanism. The wheels 100 enables ease of movement by the user and the triangular portion allows stabilization of the rodder reel when in place. Additionally the drum 101 onto which the cable is wound onto, can be disassembled from the rodder reel such that the user can transport the rodder reel in two parts making the lifting and transportation of the rodder reel easier.

The installer tool may be transported assembled in complete form, in collapsed form (if it is telescoping) and/or in disassembled form, or some combination. The size of the installer and/or components is suitable for installation in a mine and/or transportation. As an example, the conduit and/or pole could be between 3-7 m in length; and the broken down lengths can be or are configured to fit on the back of a lightweight vehicle tray, which is generally <about 2.5 m. The diameter of the conduit is of sufficient size to fit the measurement tool and centralisers that are fitted to the outside of the tool.

### 3. Exemplary Embodiments—Rodder Reel

The installer 10 apparatus above is described with referenced to a general rodder reel 16 for context. The installation assembly 1 can comprise an installer 10 and a general rodder reel 16 as described above.

In yet another embodiment, an improved rodder reel 16′ is provided as described below. However any of the improved rodder reels can be used with the installer 10 above in the overall assembly 1.

In general terms, the rodder reel embodiments have:
a rodder reel frame comprising:
   a base,
   a cable reel support,
a wheel and handle support(s) (together termed “transportation support”); and
a cable reel on the cable reel support, and
a handle and wheel for transportation on the transportation support.

These can take various forms as shown in the embodiments below. The rodder reel frame and rodder reel generally might also have other items (and components for supporting such items) such as an encoder, additional components, tools and the like.

The rodder reel frame comprising the base, cable reel support and/or transportation support, wheel and handle is configured so that the rodder reel is as best as possible balanced to be easily manoeuvred by a user, even in difficult situations. In general, the rodder reel when provided with a handle, a frame portion with the cable reel, and a wheel on the opposite side to the handle, is very much like a wheelbarrow. This wheelbarrow configuration enables greater ease of use through ready manoeuvrability, with a simple lift and move action. The frame portion can be lifted by the handle as it pivots on or about the wheel on the ground, manoeuvred about and then placed down into a resting orientation for ready use, with the frame base on the ground, preferably in a stable condition.

The rodder reel is constructed from materials, and configured in a manner to minimise the weight as much as possible, such as about 20 kg or below. Additionally, the weight distribution and/or the centre of mass being arranged to enable as best as possible this ease of manoeuvrability even in difficult situations, such as when used in underground conditions, uneven ground, presence of ground water, etc.

The base is arranged such that when the rodder reel is set in place, the base provides stability. This is important for surveying, where there needs to be minimal movement to ensure accurate surveying. The base is arranged such that the apparatus can be manoeuvred easily and then simply “dumped” in a suitable location which will be relatively stable, without the need for difficult adjustment or rearrangement.

### 3.1 First Alternative Embodiment of Rodder Reel

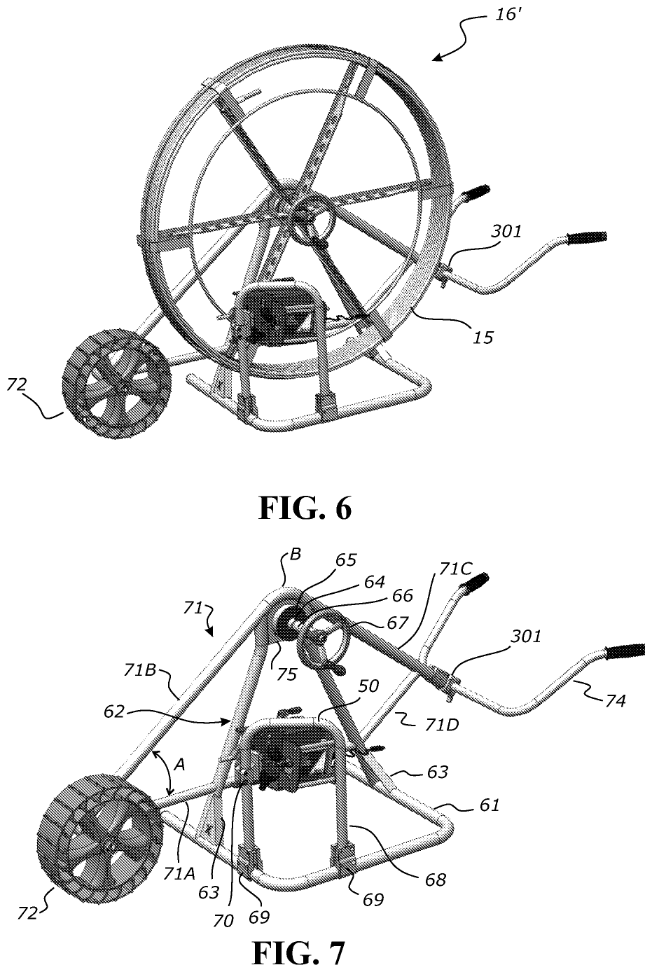

In one embodiment, an improved rodder reel 16′ is provided as described below with reference to FIGS. 6 to 9. The improved rodder reel 16′ can be used with the installer above in the overall assembly 1.

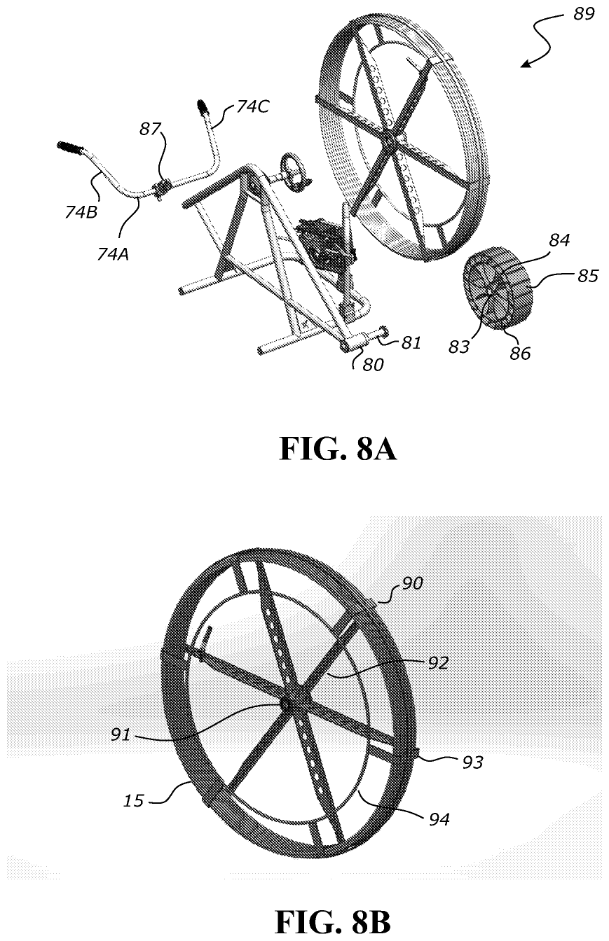

FIG. 6 shows the improved rodder reel 16′ with a cable 15 reeled thereon. FIG. 7 shows the rodder reel 16 without a cable reel (holder). FIG. 8A shows the rodder reel in exploded form. FIG. 8B shows the cable reel.

The rodder reel 16′ comprises a base 61 that provides stability for the rodder reel 16′. The base 61 may take any suitable shape, such as (without limitation) a quadrilateral or partial quadrilateral shape, or a triangular or partial triangular shape. In this case, it is formed as a three sided quadrilateral U-shape, formed of a bent tubular section member (tubing). The base tubing 61 can be aluminium, carbon fibre or any other suitable metal, plastic, composite or other rigid material.

Extending up from the base is a spool gantry 62 (cable reel support). The spool gantry can take any suitable shape, but in this case is formed of two tubular section members (tubing) 62 that are coupled to the base 61 and extend upright at a converging angle. The upper end of both tubes 62 are bent into a more vertical orientation, and a cross member component 75, such as a plate or bar, extends therebetween. The spool gantry tubing 62 can be connected in any suitable manner to the base, either integrally or through some type of welding, coupling or other means. Bracing 63 is provided at the bottom of each spool gantry tube 62 where it intersects with the base 61 to provide stability and rigidity. The spool gantry tubing 62 can be aluminium, carbo fibre or any other suitable metal, plastic, composite or other rigid material. It will be appreciated that other configurations of spool gantry 62 are possible.

An encoder gantry 68 is provided. The encoder gantry 68 can take any suitable shape, but in this case is formed of a tubular section member (tubing). The encoder gantry tubing 68 can be connected in any suitable manner to the base 61, either integrally or through some type of coupling 69, such as clamps, welding, integrally formed or other suitable means. The encoder gantry tubing can be aluminium, carbon fibre or any other suitable metal, plastic, composite or other rigid material. It will be appreciated that other configurations of encoder gantry 68 are possible.

A spool 64 is rotatably attached to the spool gantry cross member 75. The spool can take any suitable configuration, such as a circular plate end 65 with a central section that a spindle 66 runs through. A handle 67 for rotating the spool can be provided. Provided on the spool is a cable reel (reel holder) 90, with a central hub 91 and spokes 92 leading to cable brackets 93 that bend in a U-shape and attach to a central annular ring 94. A cable 15 can be spooled on the inside of the brackets 93. The spool 64 and cable reel 90 can jointly be considered a reel.

The rodder reel 16′ comprises a transportation frame 71 (transportation support) that is formed from a bent tubular section member (tubing). The transportation frame comprises a base section 71A which is attached to the spool gantry 62, or any other suitable place, for example the base 61. The transportation frame base 71A can be coupled in any suitable way, in this case, bypassing through the spool gantry 62 and attaching with welding or other similar attachment means. The transportation base tubing 71A then bends back on itself at an angle A and extends to form a support section 71B. At the apex of the angle A, there is a bearing arrangement 80 and axle 81, to which a wheel 72 can be rotationally attached. The wheel is formed of preferably some lightweight yet robust material, such as a plastic, metal or similar lightweight material, where the wheel can be provided with spokes. It has a hub 83 to rotate on the axle 81. The spokes 84 support a circumferential bearing surface 85. The bearing surface could take the form of a dual concentric ring with compliant webbing 86 between the rings that provide some degree of compliance to mimic a tyre. There could be one or more wheels.

The other end of the support section 71B is attached to the top of the spool gantry 62, and bends over at an angle B to a handle section 71C. A support section 71D extends between the base section 61 and the handle section 71D to complete the transportation frame 71. A rodder reel handle 74 formed with a central bar 74A has two extending handles (like bike handles/handle bars) 74B, 74C is attached at the central bar 74A to the handle section 71C of the transportation frame 71 connected in any suitable manner to the base 61, either integrally or through some type of coupling 87, such as clamps, welding, integrally formed or other suitable means. The clamp can be provided with a clamp handle 301 that can allow the handle 74 to be moved about allowing the user to raise or lower the handles as required, and for transportation purposes can be folded down to allow for ease of movement. The arrangement is such that the wheel 72 and handle 74 are placed in a manner to enable the rodder reel 16′ to be manoeuvred/transported in a similar fashion to, for example, a wheelbarrow. The arrangement can be configured so that the entire assembly is balanced to enable easier transportation and manoeuvrability.

This is just one form of the transportation frame 71, and any other suitable frame 71 could be provided that supports a wheel 72 on the rodder reel assembly 16′, and provides a connection point for a handle 74. A transportation frame can be connected to the base gantry or any other part of the rodder reel directly or indirectly in any suitable manner.

The cable reel 90 itself is mounted on one side of the rodder reel frame to enable quick release by a user (similar to a bike wheel).

An electronic device (user interface device), such as a tablet computer, can be supported at a suitable location on the rodder reel frame. For example, it could be supported on the handlebars 74 to enable a user to readily use the user interface device while the rodder reel is in situ or being moved. Alternatively, the user interface device can be above mounted/placed by the handles or on the backside of the reel itself—i.e., on the same side as the encoder. The user interface device could be mounted on a ball joint so that it can rotate around to a suitable place for the user to view. This is important as the user whilst deploying the tool into the hole the user can readily turn to look at the user interface device.

Referring to FIGS. 6 and 7, the handle 67 can function as a brake handle that also rotates the spindle. A plate is provided on the cable reel and the circular plate 65 acts as a friction brake when the handle is used. This can assist the user while deploying the tool. For example, when the tool is being initialised the brake can stop additional cable being played out. The brake can hold the tool/cable when being fed into an overhead hole. Or, the brake can be used to stop or slow the tool/cable as it moves, in some embodiments this may be downhole.

The base 61 (that can optionally form part of the spool gantry), spool gantry 62 (cable reel support) and transportation frame 71 (transportation support) form a rodder reel frame 89.

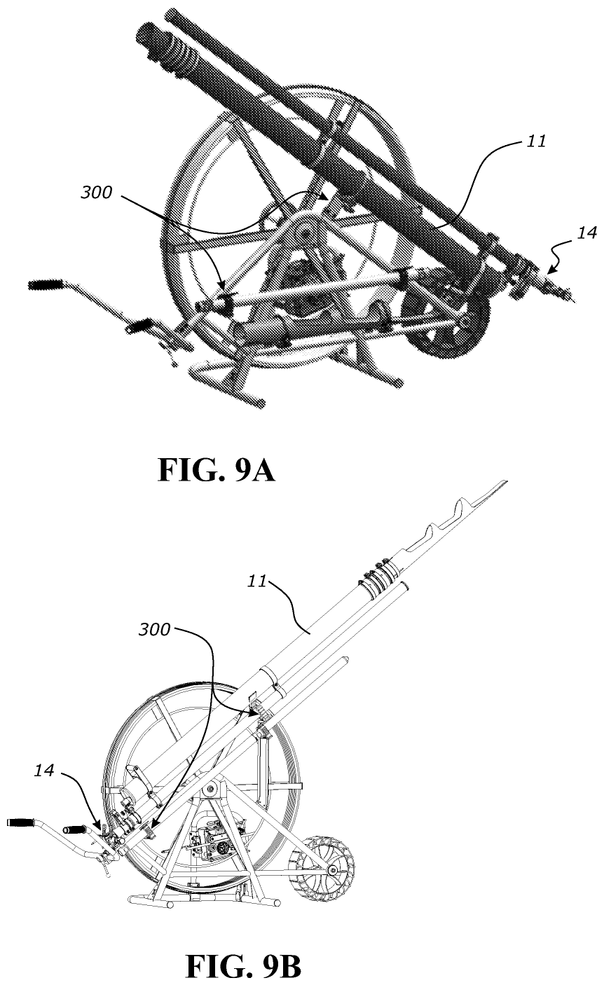

With reference to FIG. 8A, one side of the rodder reel frame, generally the side opposite to the cable reel 90, is relatively clear/free of any components, and so can optionally be used for supporting items, which might be items that are used with the rodder reel. For example, with reference to FIGS. 9A and 9B, which show two variations, supporting members 300 (such as brackets, hinges, hooks, clips, shelving, or the like) could be coupled to the opposite side of the rodder reel, such as coupled to the base, transportation frame and/or spool gantry. Such supporting members could support or provide space to support a survey tool 14, installation apparatus 11, electronic devices, tools, any other of the items described herein or the like. This enables one or more components/equipment of the entire system 1 be transported to site, for example, from a vehicle. This has time and increased efficiency advantages as the user can transport everything to the site for surveying, rather than having to go back to the vehicle to collect any other additional components to carry out the survey.

This embodiment has the advantage that the handle does not need to be lifted as far vertically to engage the wheel with the ground and to subsequently clear the base from the ground.

In a variation, the transportation frame 71, base and/or other parts of the rodder reel frame can be configured such that the wheel sits off the ground when the base sits on the ground and the rodder reel is in the resting orientation. For example, base section 71A could extend upwards at an angle and/or support section 71B could be at a shallower angle relative to the ground to position the wheel off the ground during a rest orientation. Angles A, B could change accordingly.

The handle section 71C could be at a steeper angle and/or extend closer to the ground to place the handle 74 closer to the ground. This can facilitate lifting, lowering and manoeuvring.

### 3.2 Second Alternative Embodiment of Rodder Reel

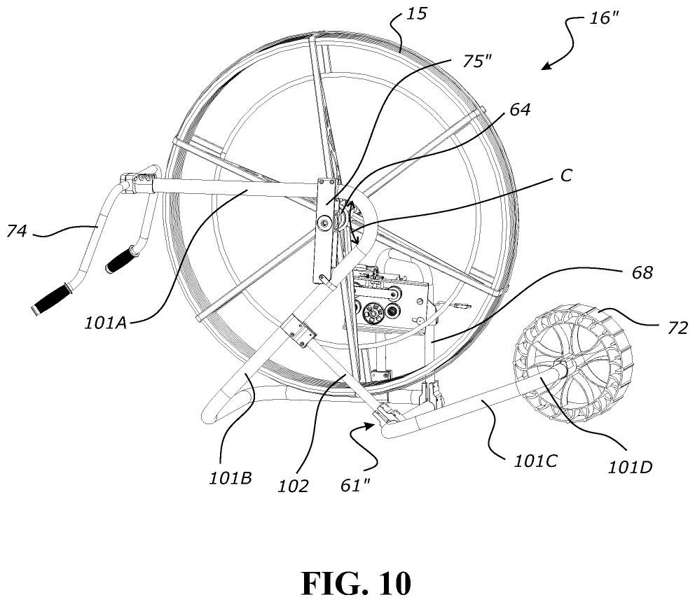

In another embodiment, an improved rodder reel 16″ is provided as described below with reference to FIG. 10. The improved rodder reel 16″ can be used with the installer 10 above in the overall assembly 1.

The improved rodder reel 16″ has rodder reel frame 101 constructed of a single formed tube 101A that provides the base 61″, cable reel support and transportation frame. The rodder reel frame 101 can be aluminium, carbon fibre or any other suitable metal, plastic, composite or other rigid material. The angles and orientations referred to herein are exemplary only, and could differ as will be known to those skilled in the art. The wheel is held off the ground when the rodder reel 16″ is set in place on the base 61″. This can assist with stability as the wheel is no longer a contact point and stability is provided by the “U” shaped platform. It can be envisaged that the base does not necessarily need to be “U” shaped and can be of any configuration to provide a stable platform.

FIG. 10 shows the improved rodder reel 16″ with a cable 15 reeled thereon.

In the resting orientation, the rodder reel frame 16″ starts as a tube formed as a straight horizontal arm 101A, which can support a handle 74 (handle support), and provides one part of the transportation support.

The tube 101 then bends back on itself at an angle 101B in a vertical plane with the horizontal arm, the tube 101B extending to the ground. A cross member 75″ extends across the corner from the angled tube and the handle support arm to provide a spool support. The spool support cross member 75″ can be connected in any suitable manner to the base, either integrally or through some type of welding, coupling or other means. The spool support cross member 75″ can be aluminium, carbon fibre or any other suitable metal, plastic, composite or other rigid material. It will be appreciated that other configurations of spool gantry 62 are possible.

The angled tube 101A, 101B, 75″ and spool 64 support form a cable reel 15 support.

The tube then extends at right angles in a horizontal perpendicular base plane into a base 61″ that provides stability for the rodder reel 16″. The base 61″ may take any suitable shape, such as (without limitation) a quadrilateral or partial quadrilateral shape, or a triangular or partial triangular shape. In this case, it is formed as a three sided quadrilateral U-shape, formed of a bent tubular section member (tubing) in a horizontal base plane. There is a support bar 102 coupled between the angled tube 101B and the base 61″ to provide stability/support.

The tube 101 then bends upwards at an angle 101C again in a vertical plane (at right angles to the horizontal base plane) being the same as that for the horizontal arm/cable support plane) and then again at right angles 101D from the vertical plane to form a wheel support (which forms part of the transportation support). This arrangement keeps the wheel 72 off the ground when the rodder reel is in the resting orientation. There is a bearing arrangement 80 and axle 81 on the tube, to which a wheel 72 can be rotationally attached. The wheel 72 is formed of preferably some lightweight yet robust material, such as a plastic, metal or similar lightweight material, where the wheel can be provided with spokes. It has a hub 83 to rotate on the axle 81. The spokes 84 support a circumferential bearing surface 85. The bearing surface could take the form of a dual concentric ring with compliant webbing 86 between the rings that provide some degree of compliance to mimic a tyre. There could be one or more wheels.

An encoder gantry 68 is provided. The encoder gantry 68 can take any suitable shape, but in this case is formed of a tubular section member (tubing). The encoder gantry tubing 68 can be connected in any suitable manner to the base 61, either integrally or through some type of coupling, such as clamps, welding, integrally formed or other suitable means. The encoder gantry tubing can be aluminium, carbon fibre or any other suitable metal, plastic, composite or other rigid material. It will be appreciated that other configurations of encoder gantry 68 are possible.

A spool 64 is rotatably attached to the spool support cross member 75″. The spool can take any suitable configuration, such as a circular plate end 65 with a central section that a spindle 66 runs through. A handle 67 for rotating the spool can be provided. Provided on the spool is a cable reel (reel holder) 90, with a central hub 91 and spokes 92 leading to cable brackets 93 that bend in a U-shape and attach to a central annular ring 94 on the other side of the cable reel 90. A cable 15 can be spooled on the inside of the brackets 93. The spool 64 and cable reel 90 can jointly be considered a reel.

The cable reel 90 itself is mounted on one side of the rodder reel frame to enable quick release by a user (similar to a bike wheel).

An electronic device (user interface device), such as a tablet computer, can be supported at a suitable location on the rodder reel frame. For example, it could be supported on the handlebars 74 to enable a user to readily use the user interface device while the rodder reel is in situ or being moved. Alternatively, the user interface device can be above mounted/placed by the handles or on the backside of the reel itself—i.e., on the same side as the encoder. The user interface device could be mounted on a ball joint so that it can rotate around to a suitable place for the user to view. This is important as the user whilst deploying the tool into the hole the user can readily turn to look at the user interface device.

The base 61, spool gantry 62 (cable reel support) and transportation frame 71 (transportation support) form a rodder reel frame 89.

Similar to that shown in FIGS. 9A, 9B for the first embodiment, the side of the rodder reel frame opposite the cable reel 90 is relatively clear, and so can optionally be used for supporting items, which might be items that are used with the rodder reel. For example, supporting members (such as brackets, hinges, hooks, clips, shelving, or the like) could be coupled to the opposite side of the rodder reel, such as coupled to the base, transportation frame and/or spool gantry. Such supporting members could support or provide space to support a survey tool, installation apparatus, electronic devices, tools, any other of the items described herein or the like. This enables one or more components/equipment of the entire system 1 be transported to site from the vehicle.

This embodiment can be used where the benefit of more stability with the wheel off the ground in the resting orientation. When the user lifts the handle, the rodder reel pivots on the base bar until the wheel engages the ground, at which point the base can be leveraged off the ground where the wheel acts as a pivot point allowing the rodder reel to be moved.

A brake can be provided as per the first embodiment.

### 4. Exemplary Embodiment—Method of Operation

A method of using a measuring tool 14 in a drill hole 17 of the mine, comprising using the installer 10 to install the measuring tool 14 will now be described. The method will be described with reference to actions taken by user 18. It will be appreciated that the method does not have to take place serially in the exact order described, and this is by way of example only.

The components of the installer 10 will be brought to the mine site on a suitable vehicle, in a complete, disassembled and/or collapsed state, as appropriate. The user 18 (there might be more than one user, but will be referred to in the singular here) will then carry each of these components to the work site (underground mine) either individually where the installer will be extended, assembled or in a pre-assembled form.

The cable 15 and rodder wheel 16, 16′, 16″ will be assembled, and a depthing encoder 50 may optionally be attached to the rodder wheel. The depthing encoder 50 measures the length of cable deployed in order to determine the depth of the hole.

In an alternative embodiment, and for example using the rodder reel 16′ of the second embodiment, instead the rodder reel is ready assembled, and/or has various components of the system 1 or otherwise supported on the side of the rodder reel frame opposite the reel. That means that the rodder reel itself and the components are ready and can be transported to site, and then placed suitably in a stable fashion on the base.

The cable end that will attach to the measurement tool 14 can be fitted with a quick release tool and/or the quick release tool is detached into its complementary female and male parts where either the male or female end is attached to the cable and the complementary end of the quick release tool is fitted/attached to the measurement tool.

The support pole 12 and installation conduit 11 are then assembled and laid out on the ground. In other ways, the user can put the measurement tool 14 into the conduit first, then get the support pole and attach it to the conduit. The pole 12 is assembled with the conduit 11 by threading the rod through the apertures 33 on the collars 30 that are spaced along the conduit 11. The conduit is then positioned in place at a suitable height along the support rod using the positioning adjuster 19. If the holder 13 has not already been coupled, the clamp 47 on the holder 13 is attached to the support rod 12.

The measurement tool 14 is coupled to the cable 15 on the rodder reel 16, if not done already. If using the measurement tool support shown in FIGS. 4A/4B, then the measurement tool is placed into the opening 44 at the top of the holder and the cable is passed through the narrow opening 45 in the side of the holder and through the base slot 46. The measurement tool is then placed onto the base 42 of the holder and a coupling portion of the tool and the cable pass through the aperture 45 in the base. If using the other embodiments of the measurement tool support, then it is envisaged that the user will similarly place the measurement tool into the annular ring as shown in FIG. 4C or if using the connector shown in 4D/4F to couple the measurement tool to the middle part 46B. The purpose of the measurement tool support is to enable ease of movement of the overall system, as the user can detach the cable on the rodder reel allowing the measurement tool to be retained by, on or within the measurement tool support.

The user takes the conduit 11, support rod 12 and holder 13 assembly. The support pole 12 is then used to manoeuvre the conduit 11, to line up and/or insert the top end/opening of the conduit into the drill hole 17. The viewing/communications region 21 remains visible. The user can manoeuvre the assembled installation apparatus into position, where the conduit 11 facing upwards will be positioned in the mouth/collar of the drill hole 17 and the support pole assists with holding the conduit in the mouth. When the user 18 has placed the assembled installer 10 in or at the collar of the drill hole 17, then they can manoeuvre the support pole 12 so that the installation conduit 11 is correctly placed and then push the conduit 11 into place. The positioning adjuster 19 can be adjusted to configure the correct height from the ground to the top end of the conduit 11. Once in place, the locking nut can be tightened. The conduit 11 is then held in place by the combination of the locking nut abutting both the edge of the conduit 11 and/or the collar 30. The height is configured to ensure there is sufficient space for the correct deployment of the measurement tool 14 and ease of moving this assembled installation unit and measurement tool about.

The support pole 12 is then fixed into an upright position to hold the conduit 11 in place. For example, it can be fixed to the ceiling and floor of the mine e.g. through feet or other retainer, that are extendable to wedge or otherwise secure the pole, and therefore conduit 11, in place. Additionally or alternatively, it could be secured to a wall of the mine. The support rod 12 and conduit 11 might not be in a vertical position, but just in some upright position that is at an angle between the ceiling and the floor. In one example, securing takes place as follows. The prongs 26 at the top end of the support pole 12 are placed close to the collar of the drill hole 17 to enable a force to be applied in an upward direction that is spread about the drill hole opening rather than concentrated in one place where the formation may be crumbly or the like. At the ground (bottom opening of the installation conduit 11) the user, can then embed the support pole into the ground using a claw, foot or other type of retainer on the bottom end of the support pole 12. There can be a base for the user to stand on to embed the retainer into the ground. Alternatively, another retaining mechanism could be used to stabilise/secure the support pole 12 into the ground. It is important that the claw, foot or other retainer holds this position as when the measurement tool 14 is pushed up into the conduit 11, the weight of the tool 14 can cause twisting of the installer 10, so the retainer enables the installer 10 to not twist but retain its position.

With the installer secured in position along with the tool 14 that is retained by the measurement tool support 13, the user can then attach the other end of the connector (quick release tool) on the cable to the tool. The user then feeds the measurement tool 14 and cable 15 up through the conduit 11 as the cable is unwound from the rodder reel, the depthing encoder 50 can measure the length of cable being deployed and thus the length of the hole. The measurement tool then approaches or reaches the top end/opening of the conduit and collar/opening of the drill hole. Correct placement of the measurement tool can be determined using a detector and/or visual assessment. In this way the relative position/offset of the tool relative to a datum (e.g. the collar) is known and recorded. This can be identified by the user visibly seeing the tool through the opening/communication region 21, or the user estimating when the tool has entered the hole by measuring the distance to the collar and then playing out sufficient cable length with reference to the encoder, or there being some other device fitted to both the tool and installer to identify when the tool is at the collar. For example, the tool 14 can be provided with an indicator (e.g. light) that can be viewed through the viewing/communications region. The indicator can be fixed to the tool at a known position, such that as the light reaches the viewing/communication region 21, the user can determine the position of the tool relative to the conduit and/or drill hole. As the light reaches the viewing region the user can prepare for positioning and operation of the tool. In the alternative some type of detector/sensor arrangement could be used in place of the light.

Once the user knows the tool is in place including the centralisers which are within the drill hole, then the user will stop pushing the tool further into the hole. The user can then ensure the cable is secured at the bottom to keep it taught, preventing the cable moving about and therefore moving the tool and affecting the tool measurement or log. This can be achieved by clamping the cable to a fixed point such as on the conduit or support. In other embodiments, the rodder reel 16 could be powered to allow the tool to be fed up the conduit.

Once the tool 14 is inside the drill hole and the bottom end of the tool is at the collar of the drill hole or the tool is at a predetermined position that may be relative to the collar of the drill hole or other point such as the communication region 21, then the tool 14 is turned on or initialised via the user operating the monitoring device 29. This is achieved by communicating with the tool using Bluetooth or similar via the communication region. The monitoring device can be a tablet or other device capable of communicating and monitoring the tool. This monitoring device can be handheld, or in some embodiments is a hands free device that is provided to a headset, safety eye glasses or as part of head wear worn by a user that includes a hard hat, safety eye glasses etc. Alternatively the device is mounted on the rodder reel. The tool will then undergo an initialisation step to establish a “zero point” or reference point. When the measurement tool is a survey tool, such as a gyro (e.g., a north seeking gyro) the tool will determine the azimuth and depth at this point to establish the “zero point” in anticipation of logging the drill hole. another embodiment, prior to the user feeding the measurement tool up through the conduit, the measurement tool can undergo this initialisation step prior to being deployed, such as at ground level. This could be the case where the survey tool is, for example, a reference gyro re a gyro that is not north seeking, thus the “zero point” is provided to such a gyro from an external source, such as a survey station or the like.

At the time of initialisation the tablet and tool must carry out a “hand shake” or other similar synchronisation process between the two devices to enable the timers located on both the tablet and tool to start off together. The initialisation could include a countdown time, for example 60 seconds, at the hand shake to enable the user to have sufficient time to position the tool and carry out other tasks to ensure the tool is ready when it completes the initialisation process. What is important in this part of the workflow is that the tool is in position when it is determining the “zero point” as this establishes the reference point for the resultant logging results.

Logging can now take place.

The measurement tool after it has completed the initialisation step will then take measurements of the formation at its position along the drill hole whilst the user is pushing the tool up the hole. This will continue until the end of the hole is reached. This is a continuous surveying process. In some embodiments, the tool 14 will communicate downhole to the monitoring device via Bluetooth or powered communications through the cable that logging is complete at that location and it is ready to move to the next location. In other embodiments the surveying process is discontinuous. Here the user will know via the tablet that the tool is ready to take another reading as the timers are synchronised. The user will stop pushing the tool up the hole, the tool will take a reading and, then once completed the user will then continue this process until the hole is logged. In other embodiments the measurement tool may take measurements at set distances, (e.g., every 2 m) here the encoder 50 which again is controlled by the monitoring device (e.g. tablet) is used, where the user feeds the tool up into the hole while using the encoder to determine the distance travelled by the tool, until the next position is reached where logging takes place again. This continues until the end of the hole is reached. Surveying can also be carried out at the toe of the hole, such that surveying is carried out on both the in run and out run. In some embodiments surveying may just be carried out from the toe of the hole, where the user pushes the tool to the toe and measurement of the hole is carried out only on the out run.

Once the drill hole is surveyed, then the user can extract the measurement tool, by reeling the cable back in and extracting the measurement tool down through the conduit and back into the holder. The support pole can be removed from the ceiling, wall and/or floor and moved to the next drill hole location and the method undertaken again. The cable can optionally be removed and/or a different measuring tool positioned in the holder. Optionally at this time, if the measurement tool has an onboard memory then the user can download the logging results to the tablet.

The rodder reel 16, 16′, 16″ might be manoeuvred and repositioned multiple times during surveying. Advantageously, if the embodiment rodder reel 16′, 16″ is used, the repositioning is easy. The rodder reel 16′, 16″ is configured to make manoeuvring much easier and also stable placement much more likely without too much difficulty/fiddling.

Also the use of the rodder reel 16′, 16″ is particularly suitable when surface surveying is used, whereby the holes to be surveyed are below ground level, here the reel can be moved to be adjacent to the holes for surveying. In this case an installation apparatus might not be required as the survey tool is being deployed downhole. Irrespective the rodder reel can still be used to transport all of the system equipment on the frame.

### 5. Variations and/or Additions

The support pole and/or conduit could be extendible and/or collapsible in the longitudinal direction, preferably telescopically. This assists with transportation, assembly, installation and/or configuring to the required heights. As an example, the conduit could be a series of concentric cylindrical sections that telescope within each other. A similar arrangement could be for the support pole (full length pole). Alternatively, the support pole could comprise two or more sections, which are not continuous—e.g., a first upper section that engages the roof of the mine, and a second lower section that engages the floor and/or wall of the mine. There might be a gap between both sections (forming a partial length pole). They could be coupled on the conduit, for example.

The holder can be provided within the conduit or separate from the conduit. In the former situation, the inside diameter of the conduit is provided with retaining members to latch and retain the holder in place.

The cable is not just a deployment mechanism for the tool. Additionally, the cable can carry power, live data for immediate download/transmission in real time. The cable is of sufficient strength to be substantially rigid when deployed uphole yet has flexibility to be wound back onto the drum of the rodder wheel. This enables the user to push the tool up into the hole without there being (or being much) flex in the cable.

The rodder reel with the cable could have another measurement tool on board, such as a depthing encoder. The rodder wheel could alternatively or separately be provided with a battery or other power source to, for example, power the measurement tool thus the measurement tool would not require an onboard battery. The power source or battery could further power the communications and/or control the measurement tool.

The connector between the cable and tool could enable disengagement of the rodder reel and installation apparatus. This provides two pieces of the system being the rodder reel and the conjoined installed apparatus and measurement tool. This enables the agile manoeuvrability by one person of the installation apparatus with the measurement tool as the measurement tool is held in place by the holder.

The conduit 14 could be partially, predominantly or completely formed of a transparent or partially transparent material, such as Perspex, which makes the inside of the conduit visible. This construction could also form the viewing and/or communications region 21.

The installation apparatus might further comprise a detector for detecting correct deployment of the measurement tool in the drill hole. The detector could be located on or within the installation conduit and/or pole or elsewhere for detecting correct deployment of the survey tool in the drill hole.

### 6. Advantages

The installer described can be manually, or semi-manually deployed without the need of an elevated platform or similar apparatus. It can be readily deployed by 2 or fewer person(s) enabling increased efficiencies, improved health and safety and a simple operation that can enable a mine site to survey a greater number of holes i.e., workflows.

The installer described can be light, hard wearing, easy to lift and move about when it is all assembled.

The user can then readily move the conduit and tool to the next drill hole and then reattach the cable of the rodder reel ready to survey the next hole. This ease of movement is assisted by the fact this system enables a low centre of gravity to be created. This is important as the measurement tool may be long and thus it is important to ensure the system can be moved about easily without fear of toppling over.

The ability to detach the reel enables the installer and tool to be moved about as a single unit—where the survey tool is retained within the cavity of the conduit using the holder.

The wheel barrow arrangement enables an easy lift and move. The three bars forming the base enables a stable platform, that does not necessarily need to be flat—however provides sufficient stability for the tool and overall system.

Additionally, this wheelbarrow configuration allows for easy assembly, disassembly, and manoeuvrability for the user as it enables easy removal and re-attachment of the reel.

The frame is constructed of lightweight yet rigid material, for example aluminium, carbon fibre or the like making for ease of lifting on and off the back of a truck. This is important when there is only person, especially in an underground situation where is a move towards minimising the number of people working underground.

Further, the wheel is placed on the frame to be opposite the handle in the embodiments herein. This puts the centre of gravity relative to the pivot (wheel) in a better position As it is away from the user and allows for pivoting on or about the wheel. The prior art rodder reels have the transport wheel placed closest to the user/handle, thus when moving the prior art reels the user can often be walking in a crouched or slightly bent position. This is because the centre of gravity and/or pivot are close to the user.

There is an additional requirement of the prior art to have at least two wheels. Only one wheel is required in the present embodiments (although more are possible). With the present configuration the user is able to lift and move the rodder reel in a more upright and convenient position. Where used, a single wheel enables ease of manoeuvrability and is the point about which the direction of movement and/or turning can be made. Whereas with the two wheel configuration of the prior art-turning is much more difficult, especially so as the centre of gravity is close to the user.

Thus anything that assists the user to make their job easier poses great advantages.

1. An installation apparatus for a measurement tool in an underground mine with overhead drill holes, the installation apparatus comprising:
a support that can be removably secured to ground of the mine, and
an installation conduit that can be removably coupled to the support and, the installation conduit having a top opening configured to at least partially insert into an overhead drill hole,
the installation conduit configured to be supported in position by the support and configured to deploy a survey and/or geophysical tool through the installation conduit and into the overhead drill hole.

2. An installation apparatus according to claim 1, and further comprising
a measurement tool support positionable below a bottom opening of the installation conduit to support the measurement tool and/or peripheral components before and/or after deployment.

3. An installation apparatus according to claim 1, wherein the overhead drill hole is:
up to or about 50 m in length, or up to or about 40 m, or up to or about 30 m in length and/or
at least about 50 mm or up to or about 25 cm in diameter.

4. An installation apparatus according to claim 1 wherein the measurement tool support comprises a base and/or connector to support the tool.

5. An installation apparatus according to claim 4 wherein the base comprises an aperture configured to allow a portion of the measurement tool, or a connector and/or cable attached to the measurement tool, to protrude therethrough when the measurement tool sits on the base.

6. An installation apparatus according to claim 1 wherein the conduit comprises a viewing and/or communication region to assess the measurement tool.

7. An installation apparatus according to claim 1 wherein the support and/or conduit are extendible and/or collapsible in the longitudinal direction, preferably telescopically.

8. An installation apparatus according to claim 1 wherein the support is a pole.

9. An installation apparatus according to claim 8 wherein the pole is:
a single pole, or
a pole with plural sections, optionally with a gap.

10. An installation apparatus according to claim 8 wherein the pole has a retainer for securing the support ground.

11. An installation apparatus according to claim 1 wherein the measurement tool is one or more of
a survey tool, such as a gyro
a geological data collecting tool to collect geophysical, petrophysical,
mineralogical, compositional data and/or hole geometry data.

12. An installation apparatus according to claim 1 wherein the conduit comprises one or more support pole attachments configure to removably couple to the support.

13. An installation apparatus according to claim 12 wherein the support pole attachments comprise annular collars.

14. An installation apparatus according to claim 1 wherein the installation conduit and/or the support comprise a position adjuster configured to slidably adjust the position of the conduit relative to the support.

15. An installation apparatus according to claim 1 wherein the support can be removably secured to the ceiling and/or wall of the mine.

16. A method of installing a measurement tool in an underground mine with overhead drill holes into a formation comprising, in any order:
attaching an installation conduit to a support, the support removably securable to the ground of the mine,
aligning a top opening of the installation conduit in position with the support secured to the ground,
feeding the measurement tool through the installation conduit to deploy the measurement tool in the drill hole.

17. A method according to claim 16 further comprising determining if the measurement tool is approaching the overhead drill hole and/or is correctly placed.

18. A method according to claim 16 further comprising retaining the measurement tool and/or peripheral components in a tool support.

19. A system to survey overhead drill holes in a mine comprising:
a cable reel with cable,
an installation apparatus according to claim 1, and
a measurement tool attached to the cable.

20. A system according to claim 19, wherein the rodder reel comprises a base that supports a cable reel, at least one wheel and a handle for manoeuvring the rodder reel.

21.-45. (canceled)
